(19) United States
(12) Patent Application Publication
(10) Pub. No.: US 2004/0250205 A1
(43) Pub. Date: Dec. 9, 2004

(54) On-line photo album with customizable pages

(76) Inventor: James K. Conning, San Francisco, CA (US)

Correspondence Address: Geoffrey T. Staniford, Dergosits & Noah LLP, Suite 1450, Four Embarcadero Center, San Francisco, CA, 94111, US

(21) Appl. No.: 10/851,033

(22) Filed: May 21, 2004

Related U.S. Application Data
(60) Provisional application No. 60/472,867, filed on May 23, 2003.
(60) Provisional application No. 60/474,748, filed on May 29, 2003.

(51) Int. Cl. G09F 1/00

(52) U.S. Cl. 715/517

(57) ABSTRACT

An online photo viewing and album management system incorporating website building tools is disclosed. Photos are uploaded from a client computer to a server computer and posted in an ordered manner as separate web pages within an album. Editing tools are provided to allow for resizing, rotation annotation of the photos. The website builder component provides design tools to layout pages and set backgrounds and colors and other visual characteristics of the web pages. Editing commands are received on the server as HTTP calls that originate from the client interface. These updates are applied to the server and the web pages. As incremental updates are received, they are processed and immediately applied to the server, and as requests arrive to edit particular pages, the contents of those pages are queried from the server and assembled into source code for web pages.

### CROSS REFERENCE TO RELATED APPLICATIONS

This application claims priority from Application Ser. No. 60/472,867 and Application Ser. No. 60/474,748 pursuant to 35 U.S.C. § 119(e).

### FIELD OF THE INVENTION

The present invention relates generally to web-based photo services, and more specifically, to an on-line photo album with customizable web pages.

### BACKGROUND OF THE INVENTION

With the proliferation of digital cameras and camera-phones, and the close to zero costs of taking these pictures, the number of digital pictures being taken is growing rapidly. The digital nature of these pictures facilitates their distribution over electronic networks, thus making it very easy for people to share these pictures in familiar ways, such as through electronic mail (e-mail) or through postings on web pages. Due to limitations related to transmitting photos through e-mail, such as transmission bandwidth use and overfilled email boxes, shared websites for online viewing have become increasingly popular. The presence of photosharing websites on the Internet has flourished because they allow photographers to present their pictures to website visitors at large. These websites also have the advantage that the photos appear in an organized fashion and do not require the owner of the photos to send large files to their friends and family by email. Viewers benefit because they can look at thumbnails or web viewable image sizes without having their email accounts overloaded with large high resolution images.

Photosharing websites, also referred to as online photo albums, typically include thumbnails for easy navigation and captions with small descriptions of the photos. Photos are displayed on a single page on which the user can navigate to view different photos with their captions. Such websites can also feature automatic navigation through a series of photos through a “slideshow” function. However, these websites have the disadvantage that users typically cannot add other elements (such as graphics and text) on these pages. The problem with sharing photos using a conventional photo sharing service is that the content and functionality of the website that surrounds the photos is catered to the service itself, usually with the end goal of selling prints. The photo owner is very limited with respect to how much creativity he or she can express in the presentation of the photos, other than simply posting the photos where others can view them.

Online website builders, also referred to as personal website publishing sites, are an alternative for users who want to display pictures combined with graphics, text, or other elements. An online website builder service enables people to build a website using proprietary online tools and then publish the website on their own homepage. The editing tools enable users to select page templates and add or edit text, graphics, photos, or other elements. While website builders provide tools that could be used to create a richer presentation for sharing photos than the online photo websites, they typically lack the ease of use features inherent in online photo sharing, including automatic resizing of photos for web display, rotation of photos, and viewing of high resolution images in addition to standard web-viewable image sizes. Thus, the websites are generally not optimized for uploading and managing collections of photos, and are not particularly easy to use, as they typically require the user to go through many templates and menu options before they can add, move, edit, copy, or delete certain Web page elements.

Personal web publishing services have been developed to enable the user to make quick and lightweight updates to the user's website. When the user makes a change, only the incremental change is transmitted to the service's web servers, which provides a powerful ease of use feature for people who want to post their latest content without having to deal with the updating tasks inherent in traditional website maintenance. However, these services (often referred to as “bloggers”) typically work only with text content, and generally do not provide the album management or resizing features that are found in photo sharing services.

### SUMMARY OF THE INVENTION

An online photo sharing system that incorporates web publishing features is described. In one embodiment of the present invention, digital photos are uploaded from a client computer or wireless device to a server computer. The server computer receives the set of digital photos along with an indication by a user of where the photos are to be included in a particular online photo album or other type of web page. A first server process places the digital photos into an online photo album or other type of web page, in accordance with the user indication. Each photo belonging to an album is assigned an album order index that indicates the order that the photos are to be viewed within the album. Photos with the same index are assigned to the same album page for each unique album order index. The positional coordinates for each photo are recorded indicating where on the page the photo should be placed, as are text elements, clipart and other elements that may be assigned to each page.

An incremental update feature is also provided wherein a software program running on the web application server receives the incremental HTTP calls that originate from the client interface, applies these to the server, and serves page content to users and viewers of the web pages. The software program runs as a listener, awaiting updates and requests to view pages. As incremental updates are received, they are processed and immediately applied to the server. As requests arrive to edit particular pages, the contents of those pages are queried from the server and assembled into source code for web pages. The editing requests receive current up-to-the-minute data. As requests arrive to view particular pages, the contents of those pages are queried and assembled into source code for web pages.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a network for implementing an online photo sharing system, according to one embodiment of the present invention;

FIG. 2 is a flowchart that illustrates the general steps of uploading, organising, and editing photo in album pages, according to one embodiment of the present invention;

FIG. 3 illustrates a screen display for a page editor graphical user interface, according to one embodiment of the present invention;

FIG. 4 illustrates a screen display for a text editor graphical user interface, according to one embodiment of the present invention;

FIG. 5 illustrates a screen display for a background editor graphical user interface, according to one embodiment of the present invention;

FIG. 6 illustrates a screen display for an album organizer graphical user interface, according to one embodiment of the present invention; and

FIG. 7 illustrates a screen display for a photo moving tool graphical user interface, according to one embodiment of the present invention.

### DETAILED DESCRIPTION OF THE PREFERRED EMBODIMENT

An on-line photo album system with customizable pages is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, game playing devices, digital audio or video playback devices, or any other similar type of computing device.

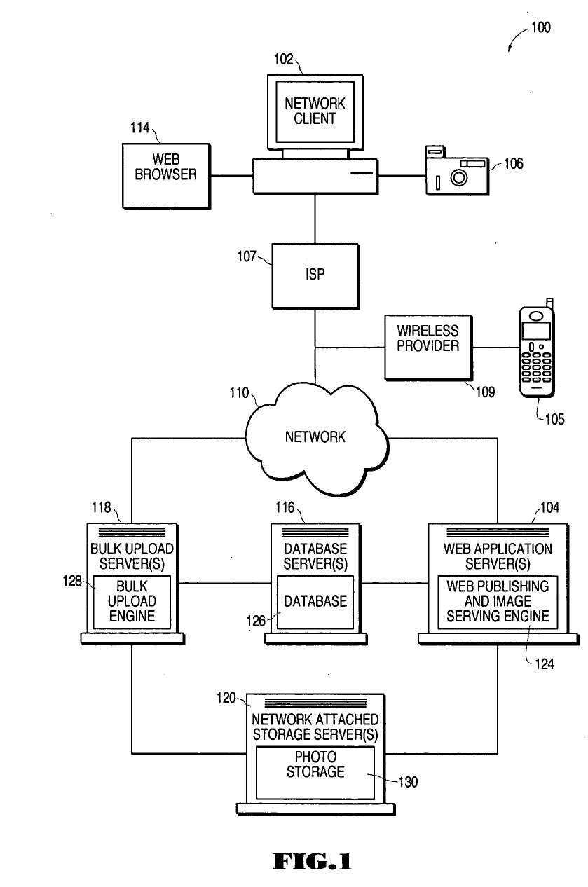

FIG. 1 illustrates an exemplary network system that includes distributed client/server computers for the distribution and use of various different graphic images, such as digital photographs. In system 100 a user employs a digital camera 106 or other photo device, such as a camera phone 105, to take photos which are downloaded to client computer 102. Camera 106 can be a still camera, video camera, scanner, or any similar digital-imaging device. The camera phone 105 can be any type of mobile phone (or similar wireless device) that incorporates a digital camera. In the case of a wireless or cellular phone, camera phone 105 typically accesses the network 110 through a service provider, such as wireless provider 109.

The photos sourced by camera 106 or phone 105 can be digital still photos, frames of digital video, scanned images, digitized analog images, and any similar type of digital image. Photo or digital image data can also be supplied for use the by the client computer 102 by one or more supplemental server computers coupled to the network 110 or directly to client 102.

For a network embodiment in which the client and server computers communicate over the World Wide Web portion of the Internet, the client computer 102 typically accesses the network through an Internet Service Provider (ISP) 107 and executes a web browser program 114 to display web content through web pages. In one embodiment, the web browser program is implemented using Microsoft® Internet Explorer™ browser software, but other similar web browsers may also be used. Network 110 couples the client computer 102 to server computer 104 which executes a web server process 116 that serves web content in the form of web pages to the client computer 102.

In one embodiment of the present invention, the photographic images captured by the camera 106 or otherwise stored in client 102 are transmitted from client computer 102 to a web application server computer (also referred to generally as the “server computer”) 104 over network 110. The server computer executes a web publishing and image serving process 124, which allows the user to upload photos from the client computer, organize the photos into album pages in which each album page is a fully customizable web page that is composed using web publishing tools. This combination of processes 124 enables the user to exercise a great deal of flexibility and creative control while sharing their photos online, and essentially enables the user to tell a story with the photos, rather simply post the photos for viewing. The entire server network of system 100 comprises, in addition to the web application server 104, a database server 116 that maintains a database 126, a bulk upload server 118 that executes a bulk upload engine 128, and a network attached storage server 120 that maintains a photo storage 130. As noted in the figure, each of the server computers may be a single computer or a sub-network of coupled server computers.

The system 100 illustrated in FIG. 1 is a platform that gives the user the ability to design and edit photo-rich personal web pages directly in the web browser 114. A WYSIWIG (what you see is what you get) design tool enables concurrent viewing and editing of the website. Incremental updates are sent to the web application server 104, which then dynamically composes web pages for both viewing and editing. Thus, each change to any web page is instantaneously updated in a server and rendered as an HTML (Hypertext Markup Language) page, directly viewable by the website visitors. The online photo albums are not treated as single HTML pages that display the various photos. Instead, albums are treated as a series of separate pages that could display one or multiple photos. This enables full customization of each page in the album.

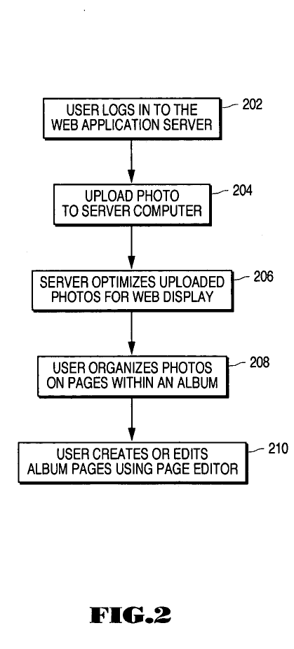

FIG. 2 is a flowchart that illustrates the general steps of uploading, organising, and editing photo in album pages, according to one embodiment of the present invention. The processes provided by web application server 104 may be implemented as a subscription based service that is provided (for free or for a charge) to various users. In this embodiment, the user sets up an account to access resources available on the server computer and utilize the photo-sharing and web-publishing processes. Thus, in step 202, the user logs in to the web application server computer 104. The user can either access an existing account or create a new account. This allows the user to execute the web publishing and image serving process 124 and store data on web pages served by the server 104.

In step 204, the user uploads one or more photos to the server computer. In one embodiment, the uploading of digital photos is accomplished through an upload function accessible in web browser 114. The user can indicate which photos on the client computer 102 he or she would like to upload and select the upload command on the displayed web page. This then transfers the picture to the server 104 and places them into a new picture repository, existing or new albums, the user's home page or other general web page.

After the photos have been uploaded to the web application server 104, they are optimized for web display, step 206. In one embodiment, a photosharing process within the web publishing and image serving process 124 includes a module that automatically creates different size (e.g., 100 and 500 pixel wide resized) versions of the uploaded picture files, and applies digital compression (e.g., JPEG compression) to the copies of these files. The 500 pixel wide versions are created for uploaded pictures that are more than 500 pixels across. If a user manually resizes a photo, the server creates another copy of the originally uploaded photo that corresponds with the new size that the user has indicated.

The web publishing process 124 includes an asset management function that allows the user to organize the photos into individual album pages, each of which is a customizable web page. This is illustrated as step 208 in FIG. 2. The user can add photos to and delete them from various albums and pages through a graphical user interface offered in the organizer mode, as well as in the tools presented in a layout mode provided by the system. In addition, the user can copy pictures onto and move them from different pages, both within and between albums, and can reorder pages within albums.

After the photos have been uploaded and organized into album pages, the user can create or edit the pages using a page editor, step 210. In one embodiment, the page editor is a function module included within the web publishing process 124. The page editor includes a layout mode for editing a particular page, which can be an album page, home page, or other web page. Through this tool, the user can add, create, edit, resize, crop, link, delete, copy, or move elements within the page. Elements could be background patterns, text blocks, pictures, buttons, clipart, callouts, animations, music, video, photo logs, guest books, and so on. Updating pages in layout mode results in the placing of a lightweight HTTP (Hypertext Transport Protocol) call from the application server to a database 126 maintained by database server 116. This call describes the changes for that particular element. The database then instantaneously renders the HTML page, and the changes are immediately visible on the live website for external viewers. Other operations, such as moving a picture to a different position on the page update the database 126 in the same manner. In one embodiment, changes to a layout page are reflected automatically on the page, thereby eliminating the need to refresh the layout page when or after the changes are made. Alternatively, the layout page can be refreshed at regular intervals by rendering the updated HTML from the server 104, which reflects the cumulative changes in the database.

Through the use of making lightweight calls to the server 104 when manipulating elements in the layout mode, followed by immediate rendering of HTML from that server allows the creation of a full personal website with all benefits of automated photo album creation. The user can not only easily upload a large amount of photos, automatically organize them in albums, automatically use them in different sizes for web display; but can also customize each page in each album as a full-fledged web page. Integrated page and site editing is implemented as a website creation tool, thereby eliminating the need to have a separate tool or page to organize, link, and manage the various web pages. The user can simply click on links that takes them to different pages to edit. He can also create, edit, or delete these links to change the overall site structure. Once a change is made, it is immediately visible in the same way that outside website viewers will see them.

The instantaneous publishing through lightweight HTTP calls minimizes any delay between making changes and making these changes available for viewing by outside viewers. The process does not require users to upload HTML or do a post to update various elements to the server. Instead, the process makes lightweight HTTP calls to the server and the database immediately generates an updated rendering of the HTML page. In one embodiment, the process enables users to change pages directly in the browser window using JavaScript and dynamic HTML. This enables fast page manipulation, and does not require loading of a web-based plug-in or applet.

Photo Sharing Process

As stated above, each album page is not only recorded as a set of photos within the album, but is also associated with a customized webpage. This functionality is performed by the web publishing and image serving process 124 executed by server 104. Photos that are placed or associated with an album page are placed onto specific locations on the page. The page background is stored as part of the customized page, as are various components that appear on the page (such as text boxes). Albums are treated as a collection of customized web pages, where photos are arranged into album pages, and a fully customizable webpage is stored for each album page.

In one embodiment of the present invention, the server computer 104 maintains five separate database tables that are stored in database 126 and that are utilized by the web publishing and image serving process 124. These tables serve to associate customized album pages with photo albums, where the images in the photo album are divided into pages. The five tables include an images table, a photo album table, a photo album images table, a pages table, and a components table. The images and photo album tables provide the mechanisms for album management, while the components and pages tables provide the ability to provide dynamic and customized webpages. The photo album images table establishes the relationship between the album management features and the customized dynamic web pages.

The images table stores a record for each photo that is uploaded to a user's website. The image itself is stored in a file on the file system of the server 104, but the image record contains adequate information to locate that image on the file system. Several files can be stored for each image, including thumbnails (e.g., 100 pixels in width), web viewable images (e.g., 500 pixels in width), high resolution images (e.g., 1024×768), and the original image that came from the digital camera. Not all image file types need to be stored for each image. For example, if the user uploaded a photo that is smaller than 500 pixels in width and height, then it is generally not necessary to create a high resolution version at 1024×768. However, if the user uploaded a large image with a size 2048×1536, then a 1024×768 image would need to be generated for use in a high resolution slideshow, since the original 2048×1536 image would be too large.

Regardless of whether there are multiple files stored for a particular uploaded image, there is still only one image record, as long as the image appears on only one album page. If the image is placed on a different page and resized on that page, then an additional image record is created, since the user has placed one photo on two different pages with different sizes for each page. In this case, the system stores two different sized images.

Table 1 illustrates the composition of the image table, according to one embodiment of the present invention.

TABLE 1

| | |
|---|---|
| image_id | Unique ID of image |
| image_type_id | JPEG or GIF |
| user_id | Unique ID of user that owns this image |
| original_file_name | File name of photo from user's computer |
| source_image_id | ID of the source image, when image is placed on a second page |
| | and resized or rotated. |
| image_size | Size in bytes of the image file as uploaded by the user |
| Width | Current displayed width of the image |
| Height | Current displayed height of the image |
| original_width | The width of the image as uploaded by the user |
| original_height | The height of the image as uploaded by the user |
| Rotation | The current rotation angle of the photo. Starts at 0 degrees and is |
| | updated when the user rotates the photo. |
| access_key | Security key that must be provided for a website viewer to view |
| | this photo. This key changes when the photo is rotated or resized. |
| original_access_key | Security key that was saved with the image when it was originally |
| | uploaded, and which stays attached to the original version of the |
| | image. |
| image_category_id | Determines whether the image is newly uploaded, has been |
| | placed on a page, or is in the Photo Trash Can. |
| Upload_date | The date and time in which the photo was uploaded by the user. |
| last_update_date | The date and time this record was last changed. |

The photo albums table stores a record of each photo album, along with the name of the album, the unique ID of the user that owns the album, and various settings that relate to the presentation of the album. Table 2 illustrates the composition of the photo albums table, according to one embodiment of the present invention.

TABLE 2

| | |
|---|---|
| photo_album_id | Unique ID of this album among all albums |
| Name | Name of the album that is displayed to the viewer. |
| user_id | Unique ID of the user that owns this album. |

The photo album images table places images into albums, and identifies what page of the album the image belongs to. The album page is identified by a number indicating the order of the page among all pages in the album, as well as by the unique ID of the corresponding web page. Table 3 illustrates the composition of the photo album images table, according to one embodiment of the present invention.

TABLE 3

| | |
|---|---|
| photo_album_id | Unique ID of the photo album |
| image_id | Unique ID of the image |
| image_index | Position of this album page |
| | among all pages in this album. |
| page_id | The unique ID of the web page that |
| | corresponds to this album page. |
| Status | Indicates whether the record has been |
| | marked for deletion. |
| last_update_date | Date and time this record was last changed. |

The pages table stores a list of customizable user web pages. In general, each maintains a single website, and each website can have many pages. Each page can be used as the Home Page, as a Named Page, or as an Album Page. Table 4 illustrates the composition of the pages table, according to one embodiment of the present invention.

TABLE 4

| | |
|---|---|
| page_id | Unique ID of this page |
| website_id | Unique ID of the website that this page belongs to |
| Owner | Unique ID of the user that owns this web page |
| is_top_level_page | Determines whether this page is a home page or not |
| Name | If this page is a Named Page, then this is the name of the page |
| | that is displayed to site visitors. |
| background_color | If the page background is set to be a solid color, then this is the |
| | HTML color code of that color. |
| music_background_id | If the page background is set to be a background image, then this |
| | is the unique ID of the image. |
| music_loop_count | The number of times the background music should loop. |
| page_order_index | If this is a named page, then this is the order of this page within |
| | the overall list of pages. |
| Status | Determines whether the page has been marked for deletion. |
| creation_date | The date and time the page was created. |
| last_update_date | The date and time the page was last changed. |

A web page is composed of components that are placed at specific locations on the page. There are several different types of components that comprise the page. These include: Text Box, where the user can type in freeform text and choose font size, style, and color; Image, which describes how an image is placed on the page; HTML, which allows the user to enter a block of HTML code; Photo Album List, which shows a list of photo albums; Page List, which shows a list of pages; Clipart, which places a clipart item on the page; Album Navigation, which are navigation arrows for moving through album pages; Page Number, which shows the current album page number, Slideshow Button, which shows a button for the album slideshow; Background Music, which plays music while a visitor views the web page; and Hit Counter, which shows the number of times the page has been viewed. Table 5 illustrates the composition of the components table, according to one embodiment of the present invention.

TABLE 5

| | |
|---|---|
| Component_id | Unique ID of this component |
| page_id | Unique ID of the web page that this component sits on |
| link_to_page_id | Unique ID of the web page that this component is |
| | hyperlinked to |
| link_to_photo_album_id | Unique ID of the photo album that this component is |
| | linked to |
| link_to_url | Internet URL that this component is linked to |
| top_position | Y coordinate of this component on the page |
| left_position | X coordinate of this component on the page |
| Width | Width of this component on the page in pixels |
| Height | Height of this component on the page in pixels |
| image_id | Unique ID of the image that this component places on |
| | the page |
| callout_id | Unique ID of the caption callout that this component |
| | displays |
| Component_type_id | The type of component |
| Component_type_specific_id | Type-specific information of this component |
| Text | Freeform text that this component displays |
| font_id | Unique ID of the font that this component uses |
| font_size | Size of the font that this component uses |
| font_color | Color of the font that this component uses |
| is_bold | Determines whether the component text is bolded |
| is_italic | Determines whether the component text is italic |
| Background_color | The background color of the bounding box rectangle |
| | that this component uses |
| visibility_type_id | Determines whether the component is visible |
| Status | Determines whether the component has been marked for |
| | deletion |
| last_update_date | Date and time the component was last changed. |

Web Publishing Process

The web publishing process 124 includes a web page design tool, referred to as a page editor. This is a web-based tool that provides viewing and editing in one interface. The page editor displays the photos and other components on the page, as they would be displayed to a website visitor, but it also adds editing tools. The editing tools come in the form of icons that show up in the corners of the components, which can be clicked on to invoke pertinent editing features. While the editing tools are present, the webpage otherwise maintains its website navigation functions. This means that if a photo would normally be hyperlinked to another webpage, so that a website visitor would click on it to go to a different page, then this hyperlinking is maintained in the page editor as well. Thus the page editor allows the user to browse the website at the same time as edit it, which facilitates the system's incremental update capability.

In one embodiment of the present invention, the page editor is implemented by a frameset that contains three frames. Exemplary HTML code of the frameset is provided as follows:

```
<frameset rows=“44,*,0” frameborder=“0” framespacing=“0”
border=“0”
  noresize>
    <frame name=“menubar”
src=http://www.funtigo.com/go?action=pemenu
    marginwidth=“0” marginheight=“0” scrolling=“no”
frameborder=“no”
    noresize>
    <frame name=“content” src=“http://www.funtigo.com/go?
    action=editview&siteid=93803&pageid=988523” marginwidth=“0”
    marginheight=“0” scrolling=“auto” frameborder=“no” noresize>
    <frame name=“loader” src=“”>
</frameset>
```

Note that in the exemplary code shown above, the frameset contains three frames. The top frame (height is 44 pixels) is the global menu that links to the other areas of the server website, such as the Organizer and Settings page. The middle frame consumes the rest of the visible height of the browser window, and contains the selected web page with editing icons. The bottom frame (set to pixel height 0 and titled “loader”) is not visible but is used by the Dynamic HTML (javascript code) to send incremental updates to the server web application server without causing the editing page to refresh.

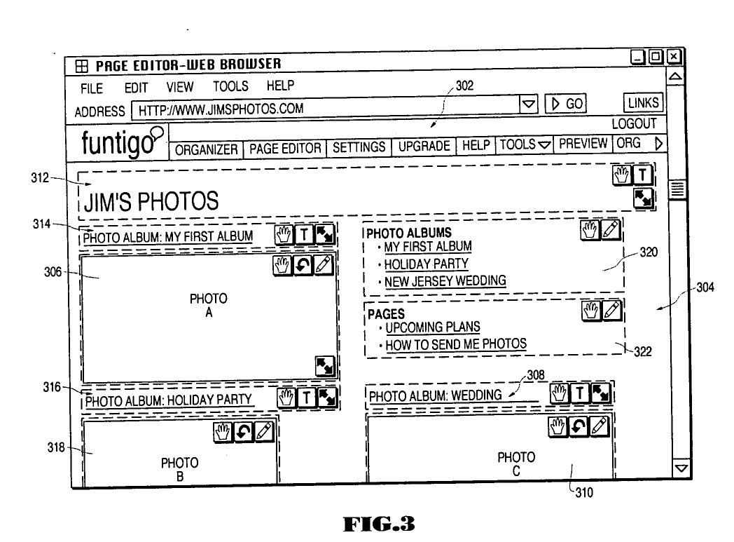

FIG. 3 illustrates a screen display for a page editor graphical user interface, according to one embodiment of the present invention. The page editor graphical user interface includes a menu navigation bar 302 displayed across the top of the screen, and an editing content area 304 below it. Screen display 300 illustrates four different types of components. These are image components consisting of the three photos 306, 318 and 310; text components, exemplified by the “Jim's photos” text box 312 as well as the three “Photo Album:” boxes 314, 316, and 308; the photo album list 320, and the named pages list 322.

Each component has its own editing icons, and the different component types have different types of icons. For example, the image components have a “rotate” icon that is used to rotate the photo, while the text components have a “T” icon that is used to edit the text. The different types of icons that include a hand, which allows the user to click and drag to reposition the component on the page; a “T” that opens a dialog box that is used to edit the text and the font characteristics, hyperlink attributes, and component background color; diagonal arrows that resizes the component, which causes the image to be resized on the server; rotate arrow, which rotates the image; and the pencil icon that is used to edit the particular component. Different component types are associated with different dialog boxes tailored to edit the particular attributes of the component.

In one embodiment, the page editor includes a javascript source file that contains event-driven code that provides the client-side editing functionality and that issues incremental update commands to the server 104. The event-driven javascript code is implemented using Dynamic HTML. When the user clicks on the editing icons, event-driven javascript functions are invoked, which make changes to the HTML and also issue incremental updates to the server computer 104. Some edits cause the editing page to refresh, while others do not. However, all editing commands cause an incremental update message to be sent to the server. When the javascript code issues an update that does not cause the editing page to refresh, it does this by setting the “loader” frame to a different URL location, which will cause the browser to issue an HTTP call to the server even though the visible area of the browser window will not refresh.

The photos shown on a web page, such as the three photos shown in FIG. 3, can be hyperlinked to the same album, or each can be hyperlinked to a separate album. If they are linked to a separate album, when the user clicks on the photo, the editing page will refresh to include the first page of the hyperlinked photo album.

Page Editor Graphical User Interface

In one embodiment the page editor function and graphical user interface includes a menu of tools that add various types of components to a customized web page. These tools include functions to add photos, add text, add callouts, add clipart, add controls, edit music, edit theme, and edit background.

The add photos tool allows the user to add photos to a page. Either new photos can be uploaded from the client computer 102, or existing photos that were already uploaded to the server 104 can be pasted on the page. When an existing photo is pasted, a component record is created to link a photo associated with the user's account with a positional (x and y) coordinate on the page. The photo can also be hyperlinked to a named page or album, to an Internet URL, or to an e-mail address.

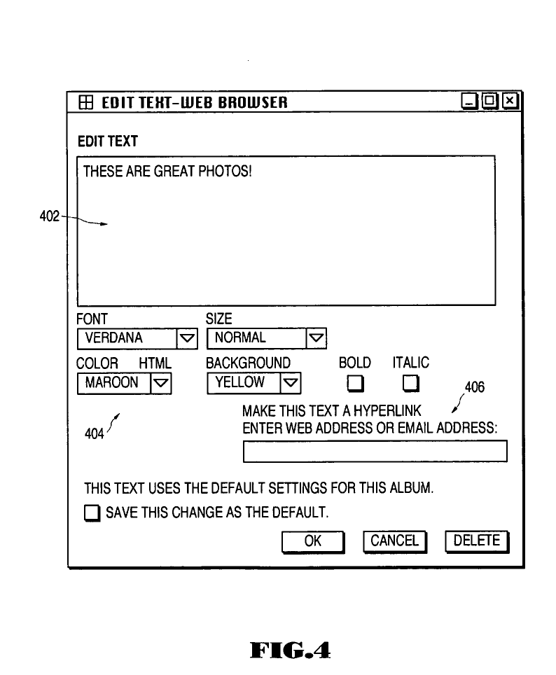

The add text tool allows the user to enter text that will be placed on the page. The user types in freeform text and chooses a font style, size, text color, and background color for the bounding box that surrounds the text. The text can also be hyperlinked to a named page or album, to an Internet URL, or to an e-mail address. FIG. 4 illustrates a screen display for the edit text tool of the text editor graphical user interface, according to one embodiment of the present invention. The user enters freeform text in the main editing screen 402 and chooses font styles and colors from the selection boxes 404. A web address can be entered in entry box 406 to make the text a hyperlink.

The add callout tool allows the user to enter text that will be placed within a resizable callout graphic. This creates an object that gives the appearance of the subjects in the photo are making comments. The user enters freeform text and chooses a font style, size, and color, as well as the type of callout graphic. The add clipart tool allows the user to select a particular clipart or similar graphic element to be placed on a page. Once the clipart is placed on the page, it can be resized. The clipart item can also be hyperlinked to a named page or album, to an Internet URL, or to an e-mail address.

The add controls tool allows the user to select a variety of miscellaneous components that can be placed on a page. The controls include shopping cart features for commerce websites, HTML components, hit counters, album navigation and slideshow controls, and so on. The edit music function allows the user to select background music for the page from a preselected list of music tracks. The music is played when a site visitor views the page. The edit theme tool allows the user to choose a theme, which is a combination of default settings for the page background and font style, size and color. The theme feature enables users to quickly apply a certain look to their album pages without customizing every page individually. Once a theme is applied to an album, individual pages in the album, or individual text boxes on the page can be overridden to contain a different setting than the album default. This allows the user to apply a color or background to an entire album, while preserving customized settings for certain pages.

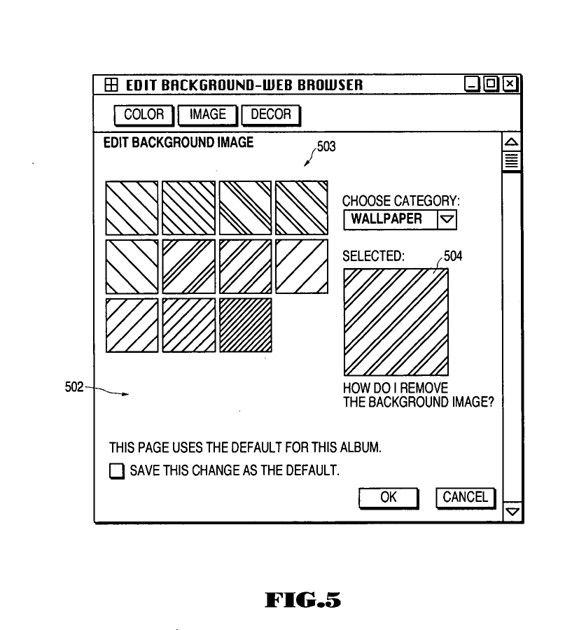

The edit background tool allows the user to select a particular background image or background color for the page. FIG. 5 illustrates a screen display for a background editor graphical user interface, according to one embodiment of the present invention. As illustrated in FIG. 5, various different background images 503 are displayed in display area 502. Various different categories of background patterns (e.g., wallpaper, clouds, colors, and so on) can be displayed, with several different selections per category. The user selects a background image to choose it. The selected pattern is then displayed in a separate display window 504.

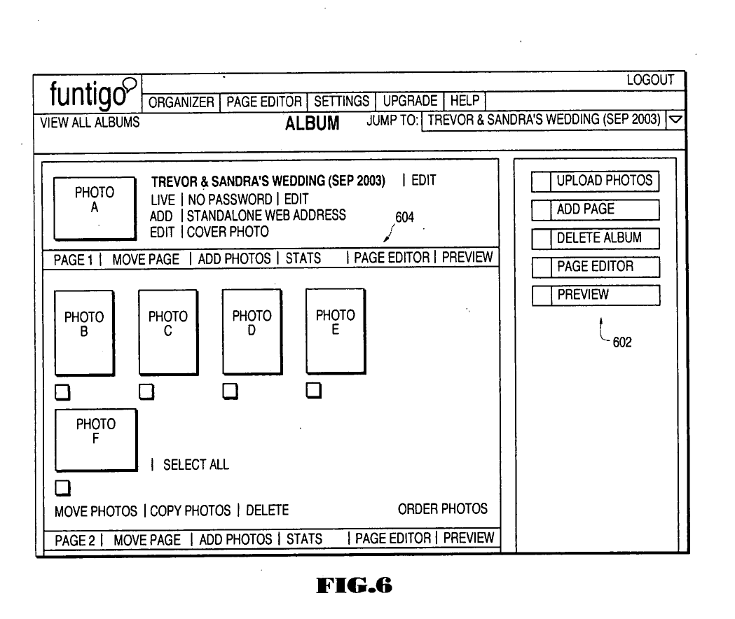

The image serving process 124 also includes an album organizer function that illustrates the pages within an album, and the photos within each page. FIG. 6 illustrates a screen display for an album organizer graphical user interface, according to one embodiment of the present invention. The album organizer interface screen includes a selection area 602 that allows a user to build and organize an album, and a toolbar menu 604 that allows a user to manipulate photos within an album. The photos to be included within an album are displayed on the main display area of the interface screen.

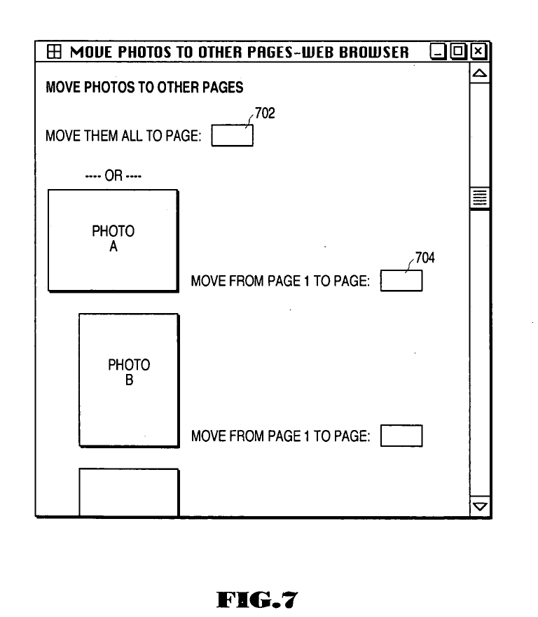

The album organizer function provides tools for each page. One such tool is the move photos tool. FIG. 7 illustrates a screen display for a photo moving tool graphical user interface, according to one embodiment of the present invention. The move photos tool includes user entry points, such as 702 and 704, which allow the user to move photos from one album to another, or among pages within an album.

System Components

The web publishing and image serving process 124 includes a web serving platform that includes three distinct tiers, a web application tier, a database tier, and a storage tier. The database tier interacts with database server 116, which maintains database 126, and the storage tier interacts with network attached storage server 120, which maintains photo store 130. In one embodiment, the web application tier is composed of web application server 104. An incoming HTTP request to the server 104 is caught by the web server. If the request is destined for the processing engine 124, the web server dispatches the request to web application server. This application server communicates with the database tier and the storage tier. The web application tier also interacts with a bulk upload server 118. This server executes a bulk upload process 128, which enables users to invoke an ActiveX control on their web browser 114 to perform a binary FTP (file transfer protocol) operation to upload multiple photos at one time. Once the files are uploaded from the bulk upload server 118, they are processed, written to the storage tier, and updates are made to the database tier. The web application tier also includes a backup server that does incremental backup of images to tape. It reads image data from the database tier and image files from the storage tier.

In one embodiment, the database tier runs a database 126 (e.g., a mysql database) that contains the data representing the customized web pages. This tier also runs batch log processing and tracks hits and unique visitors per page. The storage tier is a set of Network Attached Storage units (NAS) maintained by a storage server 120 that runs an operating system (e.g., Windows 2000) and exports files via NFS (Network File System). The physical storage devices 130 can be implemented as an array of independent disk devices, (e.g., RAID 5) or other similar storage structure.

As mentioned above, the page editor transmits incremental changes to the processing engine 124 running on the server computer 104. The engine 124 processes the change and makes an update to the database 126. Whenever the processing engine renders a page, whether that page is to be used for viewing or editing, it retrieves the current contents of the database for the particular page and its components, and dynamically renders the page. In this way, all pages served are served dynamically from the latest data, and incremental changes are immediately applied and available without a separate publishing step. Changes to web pages and photo albums are always sent to the web application server as incremental updates. This differentiates embodiments of the present invention from prior art online website builder services, which typically transmit an entire page at once and require download of client software that the user works with to create and customize a webpage, which the user the uploads as a whole page. Through the processing system illustrated in FIG. 1, this upload publishing step is eliminated, as is the processing overhead that is imposed by the upload function.

In one embodiment, the Page Editor sends incremental update messages to the processing engine in real time as the user makes changes to the page. If, for example, the user drags a text object from one position on the screen to another, then when the move is complete an HTTP call is made to the web publishing process 124 to register that change. The web application server 104 catches that HTTP call and dispatches it to the processing application, which validates the session key and inputs, processes the request, and makes updates to the database 126. The next time the page is drawn, either for use in the page editor or by a viewer of the site, then the new update is included in the page composition. In a specific embodiment, the updates are sent to a servlet named “go” and include various parameters. The HTTP call may be a GET method or POST method. The call will include a parameter named “action” which will identify the type of incremental update. An exemplary HTTP GET call is provided as follows:

http://www.funtigo.com/go?action=editposition&id=8467813&left=659
&top=619

This is a call to the “go” servlet on the server 104. The action parameter is “editposition”, which means change the position of a component on the page. The id parameter (“8467813”) is the numeric ID of the component that is having its position updated. The “left” and “top” parameters indicate the new location on the page that the component should be moved to. Also passed in the HTTP call is a session cookie named “fs”. This session key represents a current logged-in session, and allows the server to verify that the person who is logged in indeed owns the component that is being requested to be changed.

Through a dynamic page rendering process within the system, a page may be requested for view in one of two ways, which are either for viewing by a site visitor or for editing. A page drawn for viewing will have a collection of components (represented as HTML div tags) placed at their appropriate location on the page (using HTML Absolute Positioning). The components may include photos, text, and other component types (like the photo album list and the hit counter). The page may also include a background image or color, and a background music track. When a page is drawn for editing, all the items that would be included for the page in view mode are also included, as well as various editing icons and dashed lines around the component bounding boxes. The background music is not played in the page editor.

A request to display a page takes the form of an HTTP call. The parameters of the HTTP call will indicate whether the request is for a page for viewing or for editing. The request goes to the processing engine. The processing engine receives the name of the website and ID of the page (or photo album ID and photo album index if the page is part of an album) and from that queries up the website object and webpage object that correspond to that page, as well as the ApplicationUser object that represents the owner of the page. Each of these objects that is queried results in a query to the database. When the ID of the webpage is at hand, the list of component objects that sit on that page are queried. The components are then iterated and HTML is composed to represent each component. The HTML objects that are composed for any given component is built according to the type of component that is being included on the page. For example, a component that represents a photo on the page will include the HTML “img” tag, which is how an image is displayed on the webpage. Each component will be nested inside a “div” tag that has stylesheet attributes indicating the position of the component on the page. The HTML objects can be composed as part of a JSP (Java Server Pages) page and the process streams the resulting HTML out to the calling web browser.

In one embodiment of the present invention, a Java Advanced Imaging (JAI) toolkit is used to perform image processing in the web publishing process 124. When a photo that was sourced from a digital camera or other picture taking device is uploaded, the photo needs to be resized in order to effectively display it on a webpage. A photo from a digital camera may have large resolution such as 1600 pixels wide by 1200 pixels tall. Such an image will be large in file size and will be too large to draw at original resolution on most client browsers. For faster data transfer and more effective display, the images are resized by the image serving process 124. Whenever an image is resized on the server 104, the original image file is always maintained.

Three types of resized images are created normally, a high resolution image, a web viewable image, and a thumbnail image. The high resolution image is for use in the View High Resolution feature and the Slideshow. The maximum size of the image is 1024×768. The image will also be JPG compressed for file size optimization. The web viewable image is for use on web pages, and normally is 500 pixels across. The size of this image can be changed by the user with the resize tool. The thumbnail image (which is normally 100 pixels across) is for use in the Organizer, to get a quick view of all photos.

The three types of images, along with the original image, are stored on a Network Attached Storage (NAS) unit 130. To manage image storage and quick access, the images are divided into image buckets. Each image bucket has a numeric ID and holds a collection of images. There is a record in the database of each image bucket, and the code can determine the ID of the image bucket that an image belongs to from the image ID. Each image bucket is represented by a directory on one of the NAS units. The image buckets can be relocated to different NAS units in order to distribute the load of reading and writing of image files across all the NAS units.

Thus, when a digital photo is uploaded to server 104, the file is saved to disk and retained so that the original version of the photo can always be accessed. This original may be a high-resolution photo if the photo was uploaded in the format and size in which it came from the digital camera. The process 124 automatically creates a thumbnail (100 pixels across) and a high-resolution version (1024 pixels across), and are saved as different files on disk. This provides functionality over conventional website builders that typically require images to be loaded already formatted for web display and not as output from a digital camera.

With regard to particular possible implementation, in one embodiment, the application, bulk upload, and database servers run the linux operating system. Each NAS unit runs an NFS server (Network File System) that enables the linux servers to read and write to the files. The backup server reads from the NAS units in order to backup the image files. In a specific embodiment, the software modules comprising the web publishing and image serving process 124 are written in the Java programming language, using the Sun JRE (java runtime environment), and runs in the Tomcat application server, which is an open source product. The web server process is implemented as an Apache web server (another open source product) is used in conjunction with Tomcat. The bulk upload client is an ActiveX control that runs inside Internet Explorer. It communicates with the VSFTPD FTP server.

Although specific programming languages and application programs have been cited for use in conjunction with embodiments of the present invention, it should be noted that variations known by those of ordinary skill in the art can be used instead of, or in combination with the specifically cited structures and methods.

In the foregoing, a system has been described for a photo sharing service incorporated with a website builder. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer-implemented method for displaying digital photographs on a web site, the method comprising the steps of:
receiving the photographs on a server computer coupled to a client computer;
placing a first subset of photographs on a first album page within an album and placing a second subset of photographs on a second album page within the album, where in each of the first and second album pages is a fully customizable web page accessible through the web site;
providing design tools that enable concurrent viewing and editing of the web site;
sending incremental updates from the client computer to the server computer upon editing of the web sites, each incremental update of the incremental updates representing modification of the first or second album page through the use of a design tool.

2. A computer-implemented method of placing digital photos and other web page elements into online customizable photo albums or other type of web pages, comprising:
uploading a set of digital photos from a client computer to a server computer;
receiving the set of digital photos in the server computer, where the photos are indicated to be included in a particular online photo album or other type of web page;
placing the digital photos into an online photo album or other type of web page, in accordance with the indication;
assigning each photo belonging to an album order index that indicates the order that the photos are to be viewed within the album;
assigning all photos with the same index to the same album page for each unique album order index;
recording positional coordinates for each photo indicating where on the page the photo should be placed; and
assigning text elements, clipart and other elements to each page.

3. The method of claim 2 wherein the pages onto which the photos for that album have been placed are displayed in order upon viewing by an outside visitor of the online photo album, and further comprising the step of providing a navigation structure to guide the visitor through the ordered set of album pages.

4. The method of claim 3 wherein a photo can be assigned to more than one page and further wherein a photo can be assigned multiple times on a single page.

5. The method of claim 3 wherein the photo page is customized including, content, colors, and fonts.

6. The method of claim 3 further comprising the step of automatically creating and storing one or more copies of an uploaded photo, each copy created with a different resolution, and each of the one or more copies stored as a separate file.

7. The method of claim 6 wherein a first copy of the one or more copies comprises a thumbnail image, a second copy of the one or more copies comprises a page sized copy, and a third copy of the one or more copies comprises a high resolution copy.

8. The method of claim 3 wherein the background pattern of each page is individually customized.

9. The method of claim 2 wherein the digital photos are sourced from a digital camera coupled to the client computer.

10. The method of claim 2 wherein the digital photos are sourced from a camera phone coupled to the server computer over a wireless network.

11. A client interface for providing an arrangement of photos placed onto album pages, comprising:
a first set of tool icons that enable the user to drag and move photos and other elements around the page;
a second set of tool icons that enable the user to edit the elements on the page.
a page editor that enables the user to keep the edited page in view while performing edits in a floating window;
an incremental update process that transmits messages to a server storing the photos for each individual update, without having to save the entire contents of the page at once; and
a redraw process that redraws only the effected portion of the editing page for incrementally updated edits, without having to reload the entire page from the server.

12. The interface of claim 11 further comprising an text addition tool that is adds a text element to the page, wherein the width and height and position of the text element is defined by the user.

13. The interface of claim 12 wherein the text contents of the text element, as well as the font, size, text color, and background color of the element, the interface further comprising a hyperlink conversion tool to convert the text into a hyperlink.

14. The interface of claim 12 further comprising a picture placement tool for placing a picture onto the page at a particular position.

15. The interface of claim 12 further comprising a picture add tool for uploading new photos to the server and placing the new photos onto the page or into a particular album.

16. The interface of claim 12 further comprising a object add tool for placing text on the page within a caption callout graphic.

17. The interface of claim 12 further comprising a clipart add tool for placing a clipart element on the page.

18. The interface of claim 12 further comprising a music add tool for placing music on the page, which can be activated by the website viewer by selecting a particular page element.

19. The interface of claim 12 further comprising a video add tool for placing a video element on the page.

20. The interface of claim 12 further comprising a page edit tool for setting the background color or background image of the page, as well as the color of any hyperlinks on the page.
